(19) United States
(12) Patent Application Publication
(10) Pub. No.: US 2017/0173917 A1
(43) Pub. Date: Jun. 22, 2017

(54) Compression Molded Composites from Unshredded Carpets

(71) Applicant: Nutech Ventures, Lincoln, NE (US)

(72) Inventors: Yiqi Yang, Lincoln, NE (US); Yi Zhao, Lincoln, NE (US); Gangwei Pan, Lincoln, NE (US); Helan Xu, Lincoln, NE (US)

(21) Appl. No.: 15/386,257

(22) Filed: Dec. 21, 2016

Related U.S. Application Data
(60) Provisional application No. 62/270,674, filed on Dec. 22, 2015.

(51) Int. Cl. B32B 5/26; B29C 43/52; B29C 43/00; B29C 43/20; B32B 27/08; B32B 27/32

(52) U.S. Cl. CPC B32B 5/26; B32B 27/08; B32B 27/32; B29C 43/003; B29C 43/203; B29C 43/52; B32B 2262/0253; B32B 2264/104; B32B 2305/70; B29K 2023/12

(57) ABSTRACT

Compression molded composites comprising at least two compressed layers of unshredded carpet and method of making compression molded composites from unshredded carpets.

### CROSS-REFERENCE TO RELATED APPLICATIONS

The present application claims priority to, and the benefit of, U.S. Patent Application No. 62/270,674, filed Dec. 22, 2015, which is incorporated by reference herein in its entirety.

The invention was made with government support under Contract Nos. 2012-31200-06031, 2013-31200-06031, 2014-31200-06031, 2015-31200-06031, 2012-31100-06031, 2013-31100-06031, 2014-31100-06031 and 2015-31100-06031 awarded by the United States Department of Agriculture. The government has certain rights in the invention.

### FIELD OF THE INVENTION

The invention relates to composite products and a method of forming composite products, such as polypropylene carpets, nylon 6 carpets, nylon 6,6 carpets and polyester carpets. The invention further relates to recycle and reuse of discarded carpets.

### BACKGROUND OF THE INVENTION

Carpet fibers share about 7% of the US fibers market and about 9 billion pounds of carpets are consumed annually. Every year, around 2-3 million tons of carpets are disposed of in landfills in the U.S. and 4-6 million tons are disposed of worldwide. Waste carpets have become one of the largest postconsumer solid wastes going to landfills. The U.S. carpet industry consumes about 1.4 million tons of fibers each year, including nylon (60%), polypropylene (29%), polyester (10%), and wool (1%). Nylon, polypropylene (PP), and polyester (PET) fibers are expensive synthetic polymers and such petroleum-based fibers are non-degradable and remain in landfills, leading to environmental pollution. Therefore, reusing discarded carpets would reduce environmental pollution and provide a low-cost alternative for different products.

Petro-based waste carpets could be reused as composites via shredding the carpet components and then melt blending. Compared to other approaches, such as fiber depolymerization, polyamide extraction, incineration, and fiber separation, melt blending is an ideal recycling method due to its low cost, easy operation, 100% reuse rate, and no hazardous discharge. Melt blending of carpets requires no fiber separation or latex removal, as the shredded carpet components are mixed by means of reactive extrusion and compatibilization. Shredded nylon carpets can form homogeneous thermoplastics directly by twin-screw extrusion at 250-350° C. Surface nylon and backing polypropylene melt under such high temperatures. However, adhesive particles (styrene butadiene rubber) in the carpet may be damaged or decompose. Therefore, in order to increase mechanical properties of extruded composites, compatibilizers, such as maleic anhydride grafted polypropylene, acrylic acid grafted modified polypropylene, phenol/formaldehyde resins, and epoxy resins are used to improve the mechanical properties of the blends. Compatibilizers may improve adhesion between components of the waste carpets; however, most compatibilizers are toxic.

Thus there is a need for a better system of reusing/recycling waste carpets.

### SUMMARY OF THE INVENTION

Aspects of the invention relate to compression molded composites from unshredded carpets. In some aspects, the composites are reinforced by unmelted carpet yarns, styrene butadiene rubber (SBR), and/or calcium carbonate (CaCO₃) particles. The compression molded composites have good mechanical properties, water stability, and acoustic properties.

Aspects of the invention further relate to a method of forming composites from unshredded carpets by hot temperature pressing, in particular at temperatures between 160-300° C.

Aspects of the invention further relate to use of the compression molded carpet composites in the automotive, furniture, and construction industries.

### BRIEF DESCRIPTION OF THE DRAWINGS

FIG. 1a) is a top view of compression molded composites from one layer of polypropylene (PP) carpet.

FIG. 1b) is a side view of compression molded composites from one layer of PP carpet.

FIG. 2a) shows cross-sectional view of PP carpets before and after HCl treatment.

FIG. 2b) is a back view of PP carpets before and after HCl treatment.

FIG. 2c) depicts a schematic structure of backing layers of PP carpets.

FIG. 3a) is an image of polarized SBR-coated PP backing yarns in original carpets.

FIG. 3b) shows a diffraction pattern of PP flat filaments in backing layers of original carpets.

FIG. 3c) is an image of polarized SBR-PP backing yarns separated from compression molded carpet composites (180° C. and 10 min).

FIG. 3d) shows diffraction pattern of PP flat filaments separated from compression molded carpet composites.

FIG. 4 shows the effect of SBR ratio on the mechanical properties of the compression molded composites from PP carpets.

FIG. 5 shows a comparison of sound absorption of compression molded composites from PP carpets and calcium-free PP carpets at medium/high frequency with PP films and jute/PP composites.

FIG. 6 shows the effect of CaCO₃ ratio on the mechanical properties of the compression molded composites from PP carpets.

FIG. 7 shows the effect of hot pressing temperatures and holding times on mechanical properties of the compression molded composites from PP carpets.

FIG. 8 shows the effect of concentration of nylon 6,6 carpets on the mechanical properties of the compression molded composites from nylon 6/nylon 6,6 carpets.

FIG. 9 shows the effect of hot pressing temperature and holding time on mechanical properties of compression molded composites from nylon 6/nylon 6,6 carpets.

FIG. 10 shows the effect of concentration of nylon 6 carpets on the mechanical properties of the compression molded composites from nylon 6/PP carpets.

FIG. 11 shows the effect of type of carpet reinforcement on the mechanical properties of composites using PP carpets as matrix.

FIGS. 12a, 12b, 12c, and 12d show water absorption and thickness increment of compression molded composites.

FIG. 13 shows the effect of type of carpet reinforcement on the sound absorption of composites using PP carpets as a matrix.

### DETAILED DESCRIPTION OF THE INVENTION

In accordance with aspects of the invention, unshredded waste carpets are compressed under high temperatures into composites.

Suitable waste carpets include, but are not limited to, polypropylene (PP) carpets, nylon 6 carpets, nylon 6,6 carpets, and polyester carpets. Such carpets generally comprise a backing with fibers attached thereto. The backing may have components such as styrene butadiene rubber (SBR) and calcium carbonate (CaCO₃) particles.

In accordance with aspects of the invention, the carpets may be cut into shapes and sizes suitable for compression. For example, suitable shapes may be rectangular. Any suitable size composite may be made although the compression apparatus may limit the size.

A typical carpet is made of surface layer, primary backing layer, binders, and secondary backing layer. For example, the primary backing layer and secondary backing layer are usually woven sheets from flat polypropylene filaments. The surface layer is usually made of plied yarns, such as polypropylene, polyester, nylon 6, nylon 6,6, or their blends. The plied yarns are usually woven on the primary backing layer and form loop or cut pile. Carpet binders may include water insoluble and/or water soluble mineral salts. Carpet binders are usually made from mixture of powdered calcium carbonate and liquid styrene butadiene rubber. Binders are used to glue together the primary backing layer and secondary backing layer.

Water insoluble mineral salts include but are not limited to calcium carbonate, barium carbonate, magnesium carbonate, tricalcium phosphate, calcium oxalate, calcium sulfate and calcium silicate. Water soluble mineral salts include, but are not limited to, sodium chloride, calcium chloride, barium chloride and potassium chloride. Such water soluble salts would be used especially under low moisture condition.

The compression may occur via any suitable high temperature compression apparatus such as, but not limited to, hotplate, infrared hot press, and rotary drum heat presser. The selection of a suitable high temperature compression apparatus may be based on the number of layers desired for the composite. A hotplate transfers heat to materials via direct contact, while infrared hot press transfers heat via radiation. Thus, an infrared hot press is able to transfer heat to longer distances more effectively than a hotplate. Therefore, a hot press could be used to fabricate composites from many more pieces of carpets than a hotplate. Both a hotplate and an infrared hot press could be used in a lab and in industry, depending on the number of layers desired for the composites. For example, a hot plate may accommodate 2-10 layers of carpet whereas an infrared hot press may accommodate 2-100 layers.

In aspects of the invention, compression of waste carpets forms composites having matrix and fiber and/or particle reinforcement. Generally, unmelted yarns (fibers) in the backing layers of carpet serve as fiber reinforcement, melted surface yarns (fibers) serve as matrix, and SBR/CaCO₃ serve as particle reinforcement. As a combination of two or more materials, composites have better properties than the individual components. Within the composites, the matrix is continuous phase that binds the discontinuous reinforcement together. The reinforcement phase strengthens the matrix phase, and provides strength, stiffness, or other properties to the final composites.

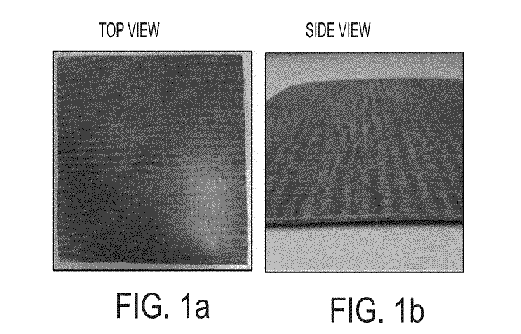

The resulting thickness of the composites is determined based on the number of layers and thickness of carpets. To show the effects of hot temperature and pressure on carpet pieces, compression molded composites from one layer of polypropylene (PP) carpet is shown in FIG. 1a and FIG. 1b. FIG. 1a) shows a top view of compression molded composites from one layer of PP carpet. Fig. b) shows a side view of compression molded composites from one layer of PP carpet. In this aspect, the compression molded carpet composite has a density of 1.3 g/cm³ and a thickness of 1.5 mm.

Preferably, more than 2 layers of carpets, for example, but not limited to 3 layers, 4 layers, 5 layers, 10 layers, 20 layers, 50 layers, 75 layers, or 100 layers, are pressed to form the composite. The thickness of the composites is based on the number of layers of carpets as well as the thickness and type of the waste carpet utilized. Typically, at least 3 layers are desired because the compression molded composites from less than 3 layers of carpets generally have poorer mechanical properties.

The carpet layers may optionally be pre-treated by, for example, steam cleaning or treatment with HCL. In general, it is not necessary to pre-treat the carpet layers.

The layers of the carpet may be placed in the compression apparatus upside up (e.g. fibers extending upwardly) or upside down. The carpet pieces may be stacked in any direction. For instance, the composites may be formed from all of the carpet pieces upside up or all of the carpet pieces upside down. The composites may also be formed with the carpet pieces alternating upside up and upside down or any combination of upside up and upside down. In particular, the composites are formed from all of the carpet pieces upside up or all of the carpet pieces upside down. Such composites have good mechanical properties.

PP fibers can serve as both fiber reinforcement and a matrix which provides compression molded composites containing PP fibers with good sound absorption and impact resistance. It is desirable that the PP yarns do not melt; thus allowing the PP in the backing layers of carpets to serve as fiber reinforcement and surface PP yarns to serve as a matrix. Generally, there is no acceptable amount of minimal melting of PP backing yarns. Notably, PP fibers are used as backing fibers and are prevented from melting by the protection of styrene butadiene rubber coat.

Nylon 6 fibers can serve as reinforcement and/or a matrix. In compression molded composites from polypropylene carpet and nylon 6 carpet, nylon 6 serves as fiber reinforcement, which provides the composites with good mechanical properties. In the compression molded composites from nylon 6 carpet and nylon 6,6 carpet or nylon 6 carpet and polyester carpet, nylon 6 serves as a matrix.

Nylon 6,6 can serve as reinforcement and/or matrix. In compression molded composites from nylon 6,6 carpet and nylon 6 carpet or nylon 6,6 carpet and PP carpet, nylon 6,6 serves as fiber reinforcement, which provides the composites with good mechanical properties. In compression molded composites from nylon 6,6 carpet and extra reinforcement fibers, nylon 6,6 serves as a matrix.

Polyester can serve as reinforcement and/or a matrix. In compression molded composites from polyester carpet and nylon 6 carpet or polyester carpet and polypropylene carpet, polyester serves as fiber reinforcement, which provides the composites with good mechanical properties. In the compression molded composites from polyester carpet and extra reinforcement fibers, polyester serves as a matrix.

SBR present in carpet composites may prevent backing PP yarns from melting so that the PP can serve as fiber reinforcement or a matrix in the resulting composite. SBR may also increase sound absorption, impact resistance, flexural strength, flexural modulus and tensile modulus of the compression molded composites from waste carpets. Typically, between 0.1-50 wt. % SBR is present in the composites. In general, during carpet manufacturing, SBR is used to glue the primary backing layer and the secondary backing layer together and is also used to coat backing yarns.

CaCO₃ present in the carpet composites may increase flexural strength, flexural modulus, and tensile modulus of the compression molded composites from waste carpets. Typically, between 0.1-50 wt. % CaCO₃ is present in the composites. In general, during carpet manufacturing, CaCO₃ is blended with SBR to glue together primary backing layer and secondary backing layer of carpet.

Carpet pieces are placed in a preheated press and then compressed to form the composite. If two types of carpet are used, the types of pieces are generally alternated. The temperature of the press and the holding time will vary depending on the composition of the carpet. Generally, the pressing temperature will be 160-300° C. with a hold time of 1 to 30 minutes.

For compression molding of composites from PP carpets or composites using PP carpets as part of a matrix, hot pressing temperature and holding time are 160-220° C. and 1-30 min, respectively.

For compression molding of composites from nylon 6 carpets or composites using nylon 6 carpets as part of a matrix, hot pressing temperature and holding time are 220-260° C. and 1-30 min, respectively.

For compression molding of composites from nylon 6,6 carpets or composites using nylon 6,6 carpets as part of a matrix, hot pressing temperature and holding time are 260-300° C. and 1-30 min, respectively.

For compression molding of composites from polyester carpets or composites using polyester carpets as part of a matrix, hot pressing temperature and holding time are 260-300° C. and 1-30 min, respectively.

The composite may be formed from layers of the same type of carpet. For example, the same type of carpet may be used having different colors, patterns, or lengths of fibers. Alternatively, layers from more than one type of carpet may be used. Such layers may be placed in any suitable or desirable order. For example, alternating layers may be PP carpet layers and nylon 6.6 carpet layers, or PP carpet layers and nylon 6 carpet layers, or nylon 6 carpet layers and nylon 6.6 carpet layers. For example, alternating layers may be PP carpet layers and nylon 6,6 carpet layers, or PP carpet layers and polyester carpet layers, or PP carpet layers and nylon 6 carpet layers, or nylon 6 carpet layers and nylon 6,6 carpet layers, or nylon 6 carpet layers and polyester carpet layers.

A composite made from only one type of carpet nonetheless may have components having a variety of melting points such that some of the components melt during hot compression and other components do not melt. For example, a carpet may contain nylon and PP.

The compression pressure may be 5 to 50 MPa, for example, 5 to 30 MPa, or 5 to 15 MPa, or 10 MPa. Percentage reduction in thickness before and after compression molding is related to density of the final composites. Generally speaking, compression molded composites with the same weight but lower thickness have higher density. Compression molded composites with higher density have better mechanical properties. In this patent, we use spacers to control thickness of the compression molded composites from the same layers of carpets.

Composites prepared in accordance with aspects of the invention have good mechanical properties, water stability, and sound absorption. In particular, composites made with alternating carpet types provide good mechanical properties, water stability, and sound absorption.

Further aspects relate to the use of the composites in transportation (e.g. automotive), furniture, and construction industries. For example, the compression molded composites have potential of serving as part of the structure of car interior; replacing plastic or wood pieces in furniture. The compression molded composites have good water stability and flexural properties, and thus have potential to be used as a floor for construction application.

Use of the composites from waste carpets will help decrease the amount of carpets disposed in landfills, reduce the need for non-biodegradable synthetic polymers, and therefore benefit the environment.

The examples which follow are intended as an illustration of certain preferred embodiments of the invention, and no limitation of the invention is implied. In the figures, data points with different numbers, letters, or symbols indicate statistically significant differences.

### EXAMPLES

In the following examples, two types of carpets were placed alternatively between two aluminum sheets and pressed in a preheated laboratory-scale press (Carver, Inc., Wabash, Ind.). The temperature of the press and the holding time varied depending on the composition of the carpet. At least 2 carpet layers were used to obtain final composites with different concentrations of unmelted carpet yarns. The thickness of the resulting composites was determined based on the layers of carpets.

### Example 1

HCl treatment of carpets was carried out to calculate the amount of calcium carbonate (CaCO₃) in carpet by dissolving CaCO₃ in HCl. PP carpets contained 40 wt. % CaCO₃, 10 wt. % SBR, and 50% PP yarns. PP yarns were mainly distributed on the surface while SBR and CaCO₃ were located between two backing layers.

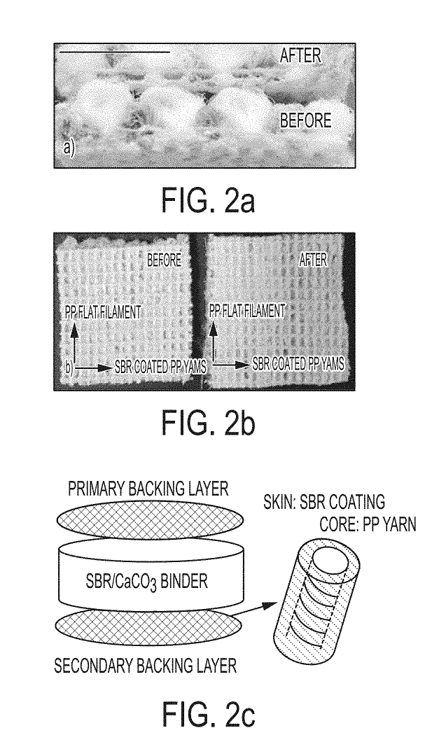

Carpets were immersed in 1% HCl for 24 h and then rinsed in distilled water for 2 h. After being dried at 50° C. for 12 h and balanced in a sealed desiccator for 2 h, the calcium-free carpets were weighed. FIG. 2a shows a cross-sectional view of polypropylene (PP) carpets before and after HCl treatment. The scale bar represents 1 cm. In FIG. 2a, the solid backing layer under the loops was observed from a cross-section of the original carpets. Obvious voids were generated between two backing layers due to removal of CaCO₃ after HCl treatment. FIG. 2b shows the back view of untreated PP carpets and PP carpets treated with 1% HCl. After HCl treatment, there was no difference in terms of integrity of the backing of the carpets.

FIG. 2c shows a schematic structure of backing layers of the PP carpets. Black lines and gray lines represent PP flat filaments and SBR-coated PP yarns, respectively; white dash lines represent CaCO₃. In the second backing layer, PP yarns in one direction were coated with SBR and woven with the uncoated PP flat filament in another direction; while in the primary backing layer, PP flat filaments in two directions were woven into sheets. The backing layers were interwoven with SBR-coated PP yarns and uncoated PP flat filaments and binding layer of SBR/CaCO₃ could influence the mechanical properties of the compression molded composites from PP carpets.

SBR coated on the backing PP yarns could prevent PP yarns from melting and allow PP yarns in the carpet to serve as fiber reinforcement and matrix, leading to good mechanical properties of compression molded carpet composites.

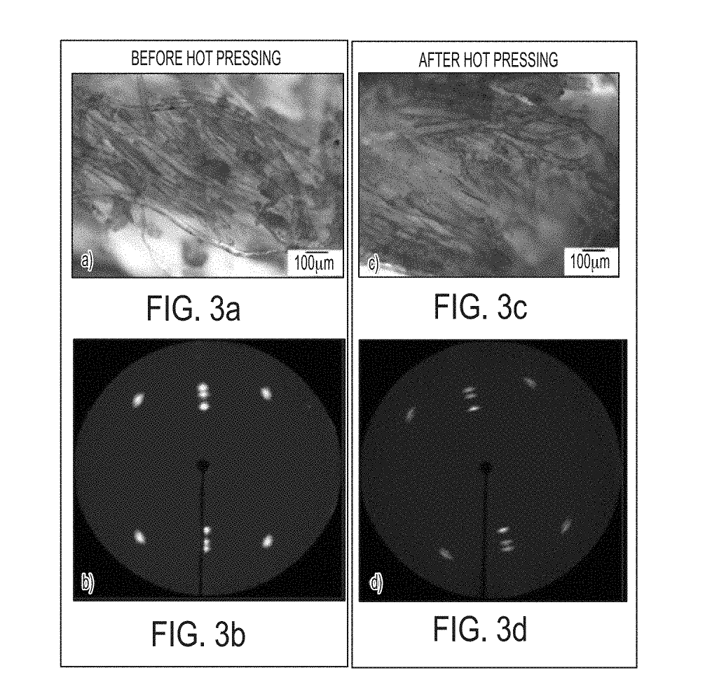

To verify the molten status of SBR-coated PP yarns and PP flat filament yarns in the carpets backing layers during compression molding, morphology of SBR-coated PP yarns and molecular orientation of PP flat filament before and after hot pressing were compared. In the secondary backing layer of carpets (See FIG. 3a—image of polarized SBR-coated polypropylene (PP) backing yarns in original carpets) the original SBR-coated PP yarns consisted of twisted PP fibers. After compression molding at 180° C. for 10 min, SBR-coated PP yarns could be separated from the compression molded composites.

Under polarized microscope, twisted PP fibers were observed from the SBR-coated PP yarns in FIG. 3c (Image of polarized SBR-PP backing yarns separated from compression molded carpet composites (180° C. and 10 min)) The SBR-coated PP yarns were not melted during hot-pressing (180° C. and 10 min) and could strengthen the final composites as fiber reinforcement. SBR has ability to insulate heat, especially at temperature lower than 300° C. (its minimum decomposition temperature), and thus could prevent coated PP fibers from melting at a hot-pressing temperature of 180° C.

FIG. 3b and FIG. 3d show diffraction patterns of PP flat filaments in backing layers of original carpets and PP flat filaments separated from compression molded carpet composites, respectively. PP flat filaments in primary backing layer of carpet before and after compression molding showed the same diffraction pattern, indicating the flat filaments before and after compression molding had the same molecular orientation. Usually, PP flat filaments in backing layers of carpets experience several drawings and show axial orientation. Whereas, molten PP should have substantially lower orientation compared to the original filaments. Therefore, the PP flat filaments in primary backing layer of carpets were also prevented from melting during compression molding at 180° C. for 10 min. Although not wishing to be bound by any theory, it is likely that the adhesive layer of SBR/CaCO₃ between two backing layers insulated heat during hot pressing. In order to verify thermal insulation of SBR/CaCO₃, the compression molded composites from the same PP carpets without SBR/CaCO₃ layer were compared. As a result, no PP flat filament was observed in the compression molded composites from the carpets without adhesive layer.

### Example 2

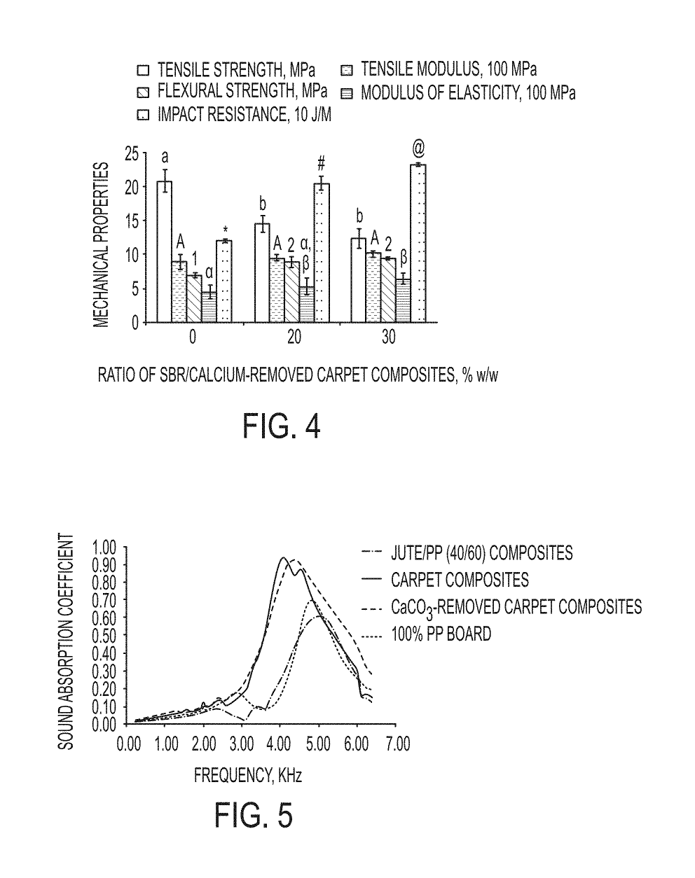

Calcium-free PP carpets with 0-30 wt. % SBR were compression-molded at 180° C. for 10 min. As shown in FIG. 4, increasing the ratio of SBR particles from 0 to 30 wt. % substantially increased impact resistance, slightly increased tensile modulus, flexural strength, and elastic modulus, but decreased tensile strength of the compression molded composites from calcium-free PP carpets. SBR solids from carpets slightly increased modulus of the composites although decreased tensile strength. SBR has good toughness and capability of absorbing impact energy. The compression molded composites from calcium-free PP carpets had better flexural properties and impact resistance than compression molded PP films. The compression molded PP films were hot-pressed sheets from pure PP without other reinforcement or matrix.

### Example 3

Compression molded composites were prepared at compression temperature of 180° C. for 10 min and tested for sound absorption. FIG. 5 shows better sound absorption of compression molded composites from 100% PP carpets and calcium-free PP carpets at medium/high frequency, compared to films from PP fibers and jute/PP (40/60) composites. At about 4.0 to 4.5 kHz, broad peaks were observed from the curves of molded composites from PP carpets and calcium-free PP carpets, indicating the composites had the highest sound absorption coefficient at medium/high frequency. Comparatively, the curves of PP films and jute/PP composites showed obviously lower peaks at about 4.8 to 5.0 kHz. It is believed that SBR in the carpet composites has high damping coefficient and thus reduced transmission of sound weave. In addition, the sound waves are more likely to be weakened by transmitting through multiple phases of materials than single or double phases of materials. Thus, the compression molded carpet composites reinforced by SBR, CaCO₃ and unmelted PP yarns had good capability of absorbing sound wave.

Comparing with jute/PP composites, the compression molded composites from PP carpets had broad peak of sound absorption, indicating their ability to absorb sound weave at wider frequency range. Sound absorption at frequency ranging from 3 to 5 kHz is desired for composites targeting transportation and construction applications because this frequency zone corresponds to noise in airport, grinding, or welding workshop. Therefore, the compression molded composites from PP carpets were more suitable for these applications compared to jute/PP composites. Compression molded composites from PP, nylon 6/nylon 6,6, PP/nylon 6, PP/nylon 6,6 and PP/PET

### Example 4

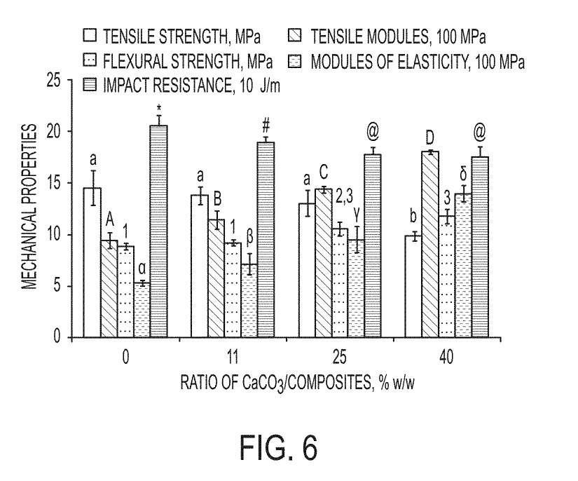

CaCO₃ will endow compression molded composites with good flexural strength, flexural modulus and tensile modulus. As shown in FIG. 6, increasing CaCO₃ concentrations from 0 to 40 wt. % increased tensile modulus, flexural strength, and elastic modulus, but decreased tensile strength and impact resistance of the compression molded carpet composites. CaCO₃ particles have high stiffness and thus could increase tensile and flexural modulus of compression molded PP composites. Due to weak interaction between nonpolar PP and polar CaCO₃, increasing CaCO₃ decreased interaction between reinforcement and matrix, thus decreased tensile strength of the composites. Flexural strength is different from tensile strength, and is affected by surface stiffness of materials. Therefore, adding CaCO₃ could improve flexural strength. FIG. 6 shows the effect of CaCO₃ ratio (0-40 wt. %) on the mechanical properties of the compression molded composites (180° C. for 10 min) from PP carpets. Density of the compression molded carpet composites is 1.3 g/cm³.

### Example 5

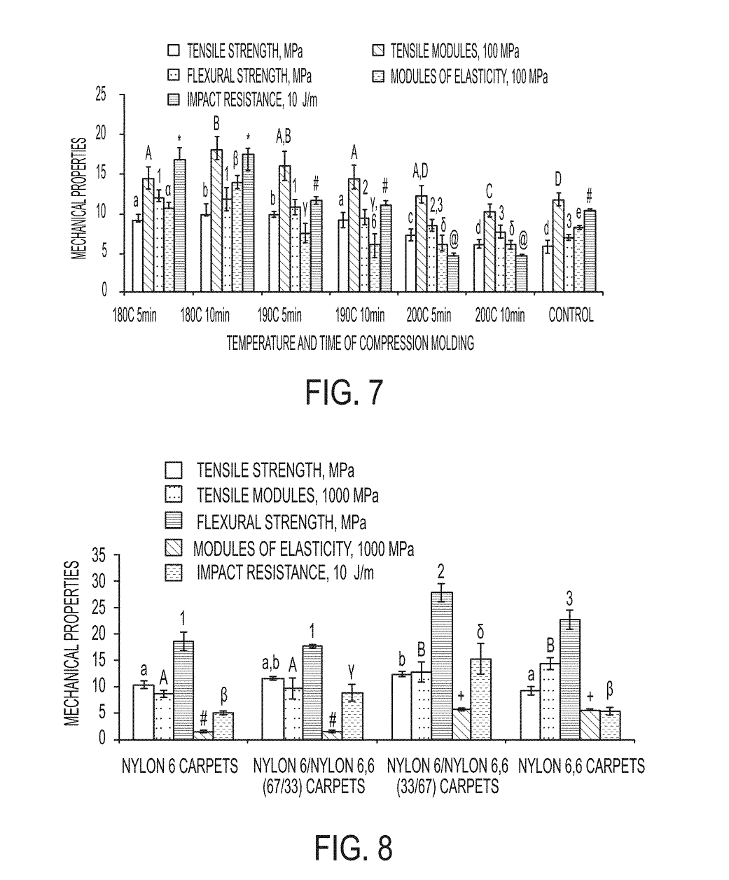

This example shows the influence of hot pressing temperatures/holding times on mechanical properties of compression molded composites from PP carpets. The control is the composites from shredded PP carpets compression molded at 180° C. for 10 min. As shown in FIG. 7, increasing temperature and time from 180° C. and 5 min to 200° C. and 10 min firstly increased and then decreased the overall mechanical properties, including tensile strength, tensile modulus, flexural strength, elastic modulus and impact resistance. Compression molded composites from one layer of PP carpets could be fabricated at 180° C. for 5 min, but cannot be formed at lower temperature due to the melting temperature of the PP (160-175° C.). Prolonging holding time to 10 min substantially improved mechanical properties of the compression molded carpet composites. It is believed this was due to melting PP having more time to thoroughly flow and combine with SBR/CaCO₃ particles and unmelted PP yarns in the backing layers.

### Example 6

This example shows the effect of concentration of nylon 6,6 carpets and hot pressing temperature/holding time on the mechanical properties of compression molded composites from nylon 6/nylon 6,6 carpets. Compression molded composites from nylon 6 carpets, nylon 6,6 carpets, nylon 6/nylon 6,6 (67/33) carpets and nylon 6/nylon 6,6 (33/67) carpets were made at 220° C., 260° C. and 240° C. for 5 min, respectively.

Compression molded composites from nylon 6/nylon 6,6 carpets (nylon 6/nylon 6,6 composites) had substantially higher mechanical properties than those from either nylon 6 carpets or nylon 6,6 carpets. Compression molded composites from single nylon 6 carpets or nylon 6,6 carpets fabricated at their respective melting temperatures had no fiber reinforcement and therefore showed comparatively low mechanical properties as indicated in FIG. 8. Increasing concentration of nylon 6,6 carpets from 0 to 33% substantially increased impact resistance of molded composites, while slightly increased their tensile properties. Further increasing concentration of nylon 6,6 carpets to 66% increased flexural strength, elastic modulus, and impact resistance of the final compression molded composites by 57%, 262% and 72%, respectively, while slightly increased tensile strength and tensile modulus. Increasing concentration of nylon 6,6 carpets from 33% to 66% increased concentration of nylon 6,6 fibers from 13.2% to 26.4% in the compression molded composites. Thus the unmelted nylon 6,6 fibers as reinforcement in the nylon 6/nylon 6,6 composites enhanced mechanical properties.

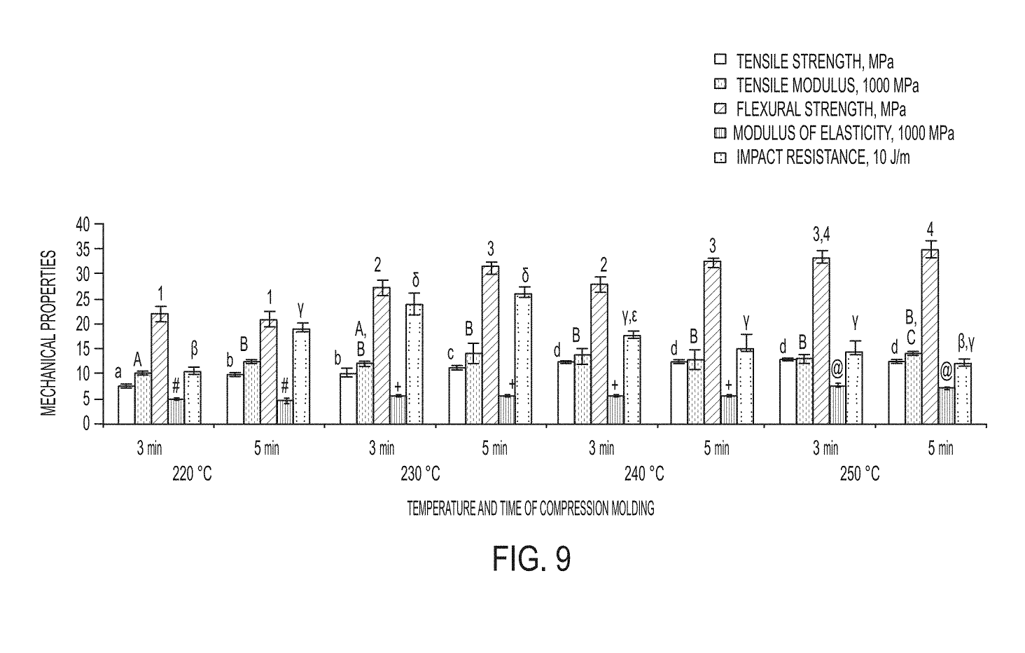

As shown in FIG. 9, prolonging holding time from 3 min to 5 min at 220° C. and 230° C. increased tensile strength, tensile modulus, flexural strength, elastic modulus, and impact resistance of the nylon 6/nylon 6,6 (33/67) composites. Increasing holding time from 3 min to 5 min at 240° C. and 250° C. decreased impact resistance of the compression molded composites from two types of nylon carpets. The nylon 6/nylon 6,6 composites had higher impact resistance at hot pressing temperature of 230° C.; while the nylon 6/nylon 6,6 composites had higher tensile and flexural strength at hot pressing temperature of 250° C. Increasing compression molding temperature and holding time increased tensile and flexural strength of the nylon 6/nylon 6,6 composites, probably due to increased adhesion between fiber reinforcement and matrix. It is believed that SBR with good damping property was damaged under high temperature, resulting in decreased toughness and impact resistance of the final composites.

### Example 7

This example shows the effect of concentration of nylon 6 carpets on the mechanical properties of the compression molded composites from nylon 6/PP carpets. Compression molded composites from PP carpets, nylon 6/PP (33/67) carpets and nylon 6/PP (67/33) carpets were made at 180° C. for 10 min, respectively, while the compression molded composites from nylon 6 carpets were made at 220° C. for 10 min.

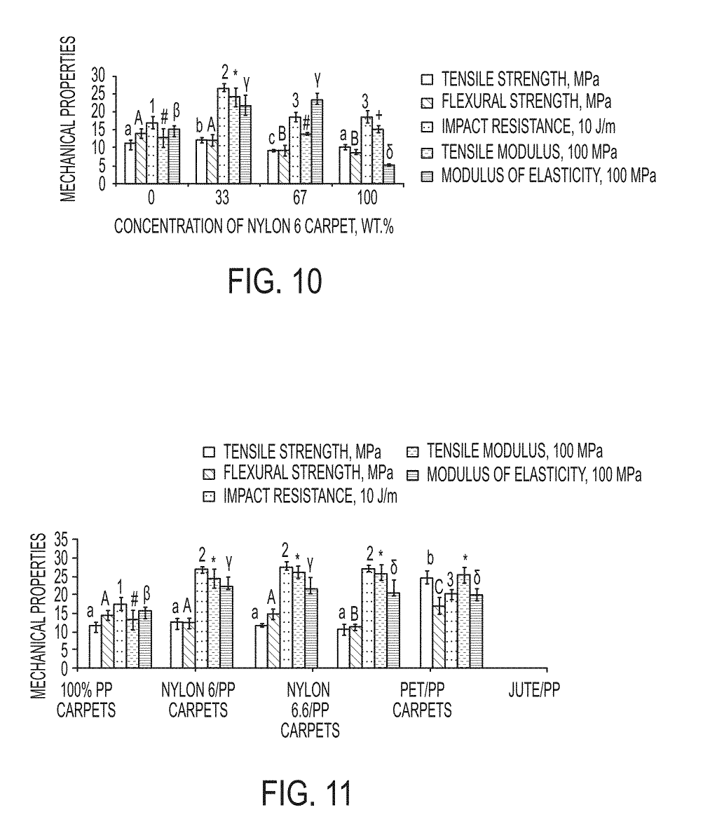

As shown in FIG. 10, the compression molded composites from nylon 6 carpets/PP carpets (nylon 6/PP carpets) have higher mechanical properties compared to the compression molded composites from PP carpets or nylon 6 carpets. Increasing weight percentage of nylon 6 carpets to 33% substantially increased flexural strength, flexural modulus, impact resistance of nylon 6/PP carpet composites; slightly increased tensile strength but slightly decreased tensile modulus. Further increasing weight percentage of nylon 6 carpets to 66% increased flexural strength, flexural modulus and impact resistance, although tensile strength and tensile modulus of the compression molded composites were not increased. Comparatively poor mechanical properties of the compression molded composites from single PP or nylon 6 carpets were mainly due to lack of fiber reinforcement under 180 or 220° C.

### Example 8

This example provides a comparison of mechanical properties, water absorption, water stability, and sound absorption of composites compression molded from different carpets. Compression molded composites from PP carpets, nylon 6/PP carpets, nylon 6,6/PP carpets, PET/PP carpets were made at 180° C. for 10 min. Jute/PP composites were also compression molded at 180° C. for 10 min as a control sample.

As shown in FIG. 11, compared to the compression molded composites from PP carpets, the composites from nylon 6/PP carpets, nylon 6,6/PP carpets and PET/PP carpets show increased flexural strength, flexural modulus and impact resistance, respectively, although no difference on tensile strength and modulus. It is mainly because fiber reinforcement in the compression molded composites from nylon 6/PP carpets, nylon 6,6/PP carpets and PET/PP carpets enhance their mechanical properties. However, reinforced nylon 6, nylon 6,6 or PET yarns with loop piles were not aligned straightly in the composites, and thus cannot substantially strengthen tensile strength of the compression molded composites. Among the three types of combined carpet composites, nylon 6,6/PP carpet composites have higher mechanical properties compared to other two. Compared to the compression molded composites from PP carpets, nylon 6,6/PP carpet composites have 60%, 88% and 40% higher flexural strength, modulus of elasticity and impact resistance, respectively. It is mainly because nylon 6,6 yarns have comparatively higher tensile strength. Compared to jute/PP composites, carpet composites, especially the composites from nylon 6,6/PP carpets, had similar or better mechanical properties. It is probably because CaCO₃ powders and SBR in carpets are beneficial to increase flexural properties and impact resistance of the compression molded composites, respectively. Therefore, using nylon 6, nylon 6,6 or PET carpets as reinforcement of compression molded PP carpet composites could enhance flexural properties and impact resistance of the compression molded composites from PP carpets.

Water absorption and thickness increment of the compression molded composites from PP carpets, nylon 6/PP carpets, nylon 6,6/PP carpets, PET/PP carpets and jute/PP immersed in 20° C. water for 1-9 days a) increment of thickness; b) water absorption; In 50° C. water for 1-9 days; c) increment of thickness; d) water absorption.

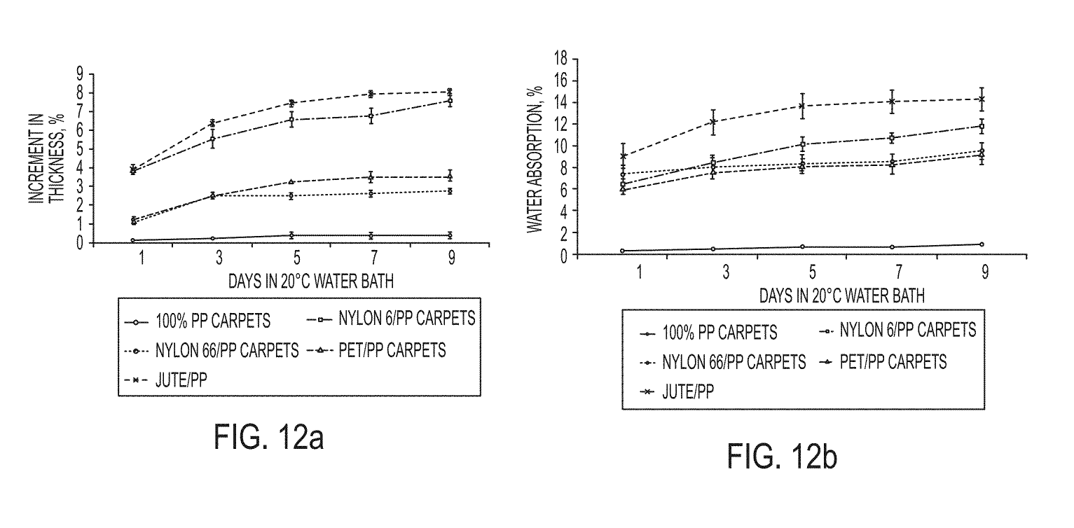

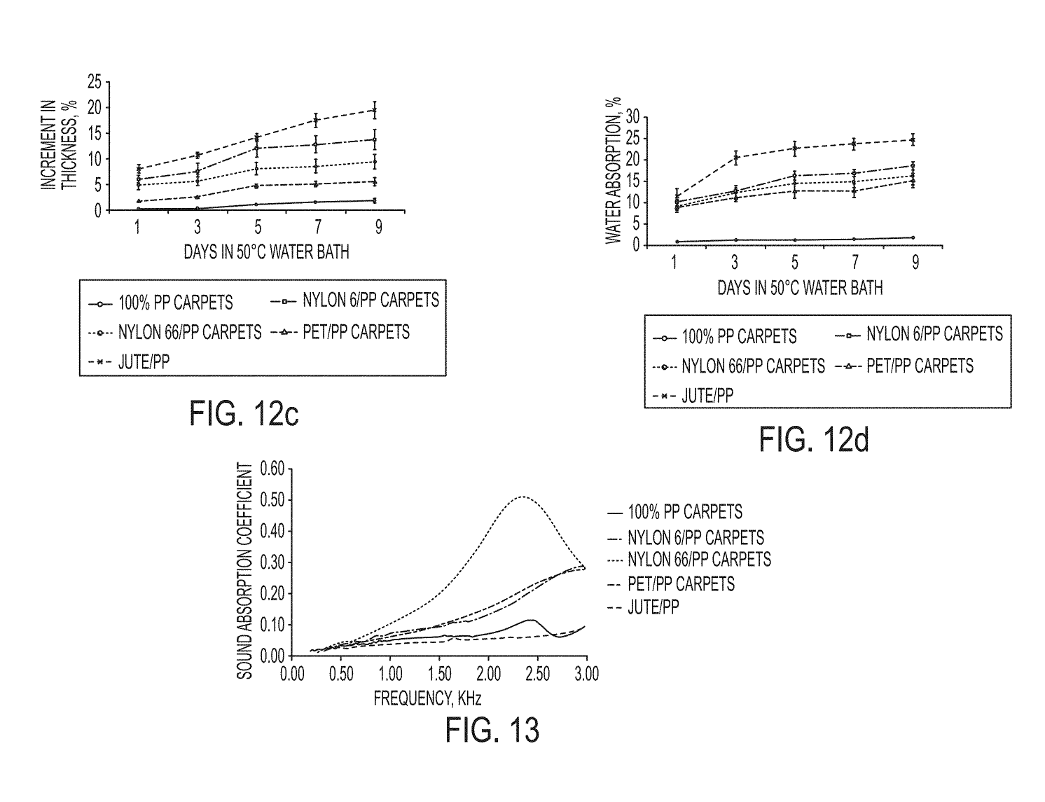

As shown in FIG. 12a-d, nylon 6/PP, nylon 6,6/PP and PET/PP carpet composites have higher water stability than jute/PP composites, but lower water stability than PP carpet composites, as immersed in 20° C. and 50° C. water for 1 day to 9 days. As seen in FIGS. 10a and 10b, Nylon 6/PP, nylon 6,6/PP and PET/PP carpet composites have higher water stability (lower increment of thickness and water absorption) than jute/PP composites, but lower water stability than PP carpet composites. Among the combined carpet composites, nylon 6,6/PP and PET/PP carpet composites have higher water stability than nylon 6/PP carpet composites. As shown in FIGS. 10c and 10d, prolonging immersing day in 50° C. water bath for 9 days deteriorates water stability of the compression molded composites, although nylon 6/PP, nylon 6,6/PP and PET/PP carpet composites have lower increment of thickness and water absorption than jute/PP composites. Jute fibers are hydrophilic and swell easily in wet condition (Hossain, 2011), leading to increased water absorption and increased thickness of jute reinforced PP composites. Synthetic yarns in the compression molded composites, including nylon 6, nylon 6,6 and PET, have comparatively lower water absorption than jute fibers. CaCO₃ as one type of desiccant could absorb moisture. However, in the compression molded carpet composites, CaCO₃ particles were enclosed in hydrophobic SBR, and thus were not affected by water. Therefore, compression molded composites from combined carpets had satisfactory water stability under room temperature and high temperature.

As shown in FIG. 13, compared to jute/PP composites, the compression molded composites from PP carpets, nylon 6/PP carpets, nylon 6,6/PP carpets and PET/PP carpets have higher sound adsorption at frequency ranging from 0.3-3 KHz. The sound waves are more likely to be weakened by transmitting through multiple phases of materials than single or double phases of materials. Thus, the compression molded carpet composites reinforced by SBR, CaCO3 and surface yarns had good capability of absorbing sound wave. The compression molded composites from nylon 6,6/PP carpets show higher sound adsorption compared to the composites from nylon 6/PP carpets, PET/PP carpets and single PP carpets. It is probably because nylon 6,6 has higher damping property than nylon 6, PET and PP.

Sound absorption at low frequency is desired for some transportation and construction composites because this frequency zone corresponds with noise from wind, road, conversation and running engine. Therefore, the compression molded composites from combined carpets have potential for transportation and construction applications, for example, serving as acoustic board on highways, in airports, and parts of the structure of car interiors. The compression molded composites may also be useful in grinding or welding workshops and in theaters. Further applications include the use of the compressed molded composites in furniture.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A compression molded composites comprising at least two compressed layers of unshredded carpet wherein the compressed layers are formed by pressing at a temperature of at least 160° C. and pressure of 5 to 50 MPa.

2. The compression molded composites of claim 1 wherein the layers comprise one type of unshredded carpet.

3. The compression molded composites of claim 1 wherein the layers comprise multiple types of unshredded carpets.

4. The compression molded composites of claim 1 wherein the composites are formed with a hotplate, an infrared hot press, or a rotary drum heat presser.

5. The compression molded composites of claim 1 wherein the composites are formed with a hotplate and the number of layers is 3-10.

6. The compression molded composites of claim 1 wherein the composites are formed with an infrared hot press and the number of layers is 3-100.

7. The compression molded composites of claim 1 wherein the composites are formed with the carpet pieces all upside up, all upside down, alternating upside up and upside down, or any combination of upside up and upside down.

8. The compression molded composites of claim 1 comprising unshredded polypropylene carpet layers or a matrix including polypropylene carpet layers wherein the layers are compressed at a hot pressing temperature of 160-220° C. and a holding time of 1-30 min.

9. The compression molded composites of claim 8 comprising the matrix from the melted surface polypropylene yarns, fiber reinforcement of unmelted SBR-coated polypropylene yarns, and particle reinforcement comprising SBR and CaCO₃.

10. The compression molded composites of claim 1 comprising unshredded nylon 6 carpets or a matrix including nylon 6 carpet layers thereof wherein the layers are compressed at a hot pressing temperature of 220-260° C. and a holding time of 1-30 min.

11. The compression molded composites of claim 1 comprising unshredded nylon 6,6 or a matrix including unshredded nylon 6,6 carpet layers, wherein the layers are compressed at a hot pressing temperature of 260-300° C. and a holding time of 1-30 min.

12. The compression molded composites of claim 1 comprising unshredded polyester carpets or a matrix including unshredded polyester carpet layers, wherein the layers are compressed at a hot pressing temperature of 260-300° C. and a holding time of 1-30 min.

13. The compression molded composites of claim 1 further comprising reinforcement comprising at least one selected from SBR, CaCO₃ particles, and unmelted yarns.

14. The compression molded composites of claim 13 comprising 0.1 to 50 wt % SBR and/or 0.1 to 50 wt % CaCO₃.

15. The compression molded composites of claim 13 comprising unmelted yarns selected from the group consisting of polypropylene, nylon 6, nylon 6,6, polyester, jute, corn stover, glass and their combinations.

16. The compression molded composites of claim 1 further comprising at least one coupling agent selected the group consisting of silane coupling agents, titanate coupling agents, and aluminate coupling agents.

17. The compression molded composites of claim 1 wherein the unshredded carpets comprise at least one insoluble mineral salt selected from the group consisting of calcium carbonate, barium carbonate, magnesium carbonate, tricalcium phosphate, calcium oxalate, calcium sulfate and calcium silicate.

18. The compression molded composites of claim 1 wherein the unshredded carpets comprise at least one water soluble mineral salts selected from the group consisting of sodium chloride, calcium chloride, barium chloride and potassium chloride

19. A method of making compression molded composites comprising placing at least two unshredded carpet pieces in a compression apparatus and then compressing at a pressure of 5 to 50 MPa and a temperature of at least 160° C. for a holding time of 1-30 min.

20. The method of claim 19 wherein the compression apparatus is a hot plate, an infrared hot press, or a rotary drum heat presser.
